(19) United States
(12) Patent Application Publication
(10) Pub. No.: US 2019/0339478 A1
(43) Pub. Date: Nov. 7, 2019

(54) OPTICAL DEVICE

(71) Applicant: SHARP KABUSHIKI KAISHA, Sakai City, Osaka (JP)

(72) Inventors: SHOHGO HIROOKA, Sakai City (JP); YOSHIHITO ISHIZUE, Sakai City (JP); YOSHIKAZU OHARA, Sakai City (JP); HIDEYUKI KURIMOTO, Sakai City (JP)

(73) Assignee: Sharp Kabushiki Kaisha, Sakai City, Osaka (JP)

(21) Appl. No.: 16/315,102

(22) PCT Filed: May 12, 2017
(86) PCT No.: PCT/JP2017/018085

§ 371 Date: Jan. 3, 2019

(30) Foreign Application Priority Data
Jul. 5, 2016 (JP) 2016-133566

(51) Int. Cl. G02B 7/02

(52) U.S. Cl. CPC G02B 7/025

(57) ABSTRACT

The present invention is intended to realize an optical device in which an optical member and a sensor are directly bonded to each other while overflow of an adhesive onto light receiving elements is suppressed. The optical device (10) includes a substrate (11), a sensor (12) mounted to the substrate (11) and having an upper surface in which an element formation portion (16) is formed, the element formation portion including light receiving elements arranged therein to detect light, an optical member (13) arranged to face the upper surface of the sensor (12) and guiding the light to the element formation portion (16), a first bonding material (14) bonding a region in the upper surface of the sensor (12) other than effective ones of the light receiving elements in the element formation portion (16) and a surface of the optical member (13) on the side closer to the sensor (12), and a leakage prevention mechanism (15) preventing the first bonding material (14) from overflowing onto the effective light receiving elements in the element formation portion (16) on the upper surface of the sensor (12).

### TECHNICAL FIELD

The present invention relates to an optical device suitable as an optical measuring device including a sensor that detects incident light.

### BACKGROUND ART

In the field of mounting of an optical device including a sensor, such as a camera module, an optical detector, or a distance meter, high-density mounting has recently been required with a tendency toward a multifunctional device. A flexible printed circuit (also called FPC hereinafter) is widely used as a substrate to which the above-mentioned optical device is mounted. Usually, the FPC includes a flexible portion and a stationary portion, and the optical device is mounted to the stationary portion in many cases.

If the stationary portion warps, the sensor included in the optical device also warps following the stationary portion. Such a warp may affect detection of the incident light by the sensor. In the FPC to which the optical device is mounted, therefore, it is important to suppress the warp of the stationary portion.

With regard to techniques for suppressing the warp of the FPC, PTL 1, for example, discloses a technique of suppressing the warp by setting thermal expansion coefficients to be equal between the side including one principal surface and the side including the other principal surface side of the FPC. As another example, PTL 2 discloses a technique of suppressing the warp by forming substantially equal patterns on both surfaces of a base member.

Meanwhile, because optical devices mounted to mobile terminals and the likes are demanded to have lower heights, reduction in height and size of components in the optical devices is now underway. In some optical devices, an optical member, such as a lens for introducing incident light to a sensor, is arranged right above the sensor with intent to realize lower height. When the optical member is arranged right above the sensor, the optical member is fixed to a substrate in many cases.

On the other hand, PTL 3 discloses a lens mounting technique of directly bonding a sensor in which microlenses are formed to a laminated lens with an adhesive. Bonding the sensor and the lens eliminates the necessity of bonding the lens and a substrate. Therefore, the lens and the sensor can be mounted to a smaller substrate, and an overall device size can be reduced.

### CITATION LIST

### Patent Literature

PTL 1: Japanese Unexamined Patent Application Publication No. 2013-105810 (laid open May 30, 2013)
PTL 2: Japanese Unexamined Patent Application Publication No. 2009-158748 (laid open Jul. 16, 2009)
PTL 3: Japanese National Publication of International Patent Application No. 2009-544226 (laid open Dec. 10, 2009)

### SUMMARY OF INVENTION

### Technical Problem

As to the above-described prior-art technique of bonding the optical member, e.g., the lens, and the sensor with the adhesive, the inventors have found a possibility that the adhesive may overflow onto light receiving elements of the sensor and may affect detection of light. Thus, it may happen, for example, that the adhesive having overflowed onto the light receiving elements absorbs incident light going toward the light receiving elements, or that unintended reflection or refraction of light occurs due to the adhesive.

The present invention has been made in consideration of the above-described problem, and an object of the present invention is to realize an optical device in which an optical member and a sensor are directly bonded to each other while influences on light detection are suppressed.

### Solution to Problem

To solve the above-described problem, an optical device according to one aspect of the present invention includes a substrate, a sensor having an upper surface in which an element formation portion is formed, the element formation portion including light receiving elements arranged therein to detect light, an optical member guiding the light to the element formation portion, a first bonding material, and a leakage prevention mechanism, wherein the sensor is mounted to the substrate, the optical member is arranged to face an upper surface of the sensor, the first bonding material bonds a region in the upper surface of the sensor other than the element formation portion and a surface of the optical member on the side closer to the sensor, and the leakage prevention mechanism prevents the first bonding material from overflowing onto the light receiving elements in the element formation portion on the upper surface of the sensor.

An optical device according to another aspect of the present invention includes a substrate, a sensor having an upper surface in which an element formation portion is formed, the element formation portion including light receiving elements arranged therein to detect light, an optical member guiding the light to the element formation portion, and a first bonding material, wherein the sensor is mounted to the substrate, the optical member is arranged to face an upper surface of the sensor, and the first bonding material bonds a region in the upper surface of the sensor where the element formation portion is formed and a surface of the optical member on the side closer to the sensor.

### Advantageous Effects of Invention

According to the aspect of the present invention, since there is no necessity of taking into account overflow of the adhesive onto the light receiving elements, the sensor and the optical member can be bonded near the light receiving elements. Hence the optical device having a smaller size can be realized.

### BRIEF DESCRIPTION OF DRAWINGS

FIG. 1 is a plan view of an optical device according to Embodiment 1 of the present invention.

FIG. 2 is a sectional view taken along a line A-A′ in FIG. 1 when looking in a direction of arrow.

FIG. 3 is an enlarged view of a region B in FIG. 2.

FIG. 4 is a schematic view illustrating examples of the arranged position and the shape of a projection in Embodiment 1 of the present invention.

FIG. 5 is a sectional view of an optical device according to Embodiment 2 of the present invention.

FIG. 6 is an enlarged view of a region B in FIG. 5.

FIG. 7 is a sectional view of an optical device according to Embodiment 3 of the present invention.

FIG. 8 is a plan view of an optical device according to Embodiment 4 of the present invention.

FIG. 9 is a sectional view taken along a line A-A′ in FIG. 8 when looking in a direction of arrow.

FIG. 10 is a sectional view illustrating another example of the optical device according to Embodiment 4 of the present invention.

FIG. 11 is a sectional view of an optical device according to Embodiment 5 of the present invention.

FIG. 12 is a schematic view illustrating steps of forming a leakage prevention mechanism in a sensor according to Embodiment 5 of the present invention.

FIG. 13 is a plan view of an optical device according to Embodiment 6 of the present invention.

FIG. 14 is a sectional view taken along a line A-A′ in FIG. 13 when looking in a direction of arrow.

FIG. 15 is a schematic view illustrating an influence on incident light, the influence being caused by difference in refractive index of a medium between an optical member and a sensor in Embodiment 6 of the present invention.

FIG. 16 is a schematic view illustrating configuration examples of the optical member in Embodiment 6 of the present invention.

FIG. 17 is a sectional view of an optical device according to Embodiment 7 of the present invention.

### DESCRIPTION OF EMBODIMENTS

### Embodiment 1

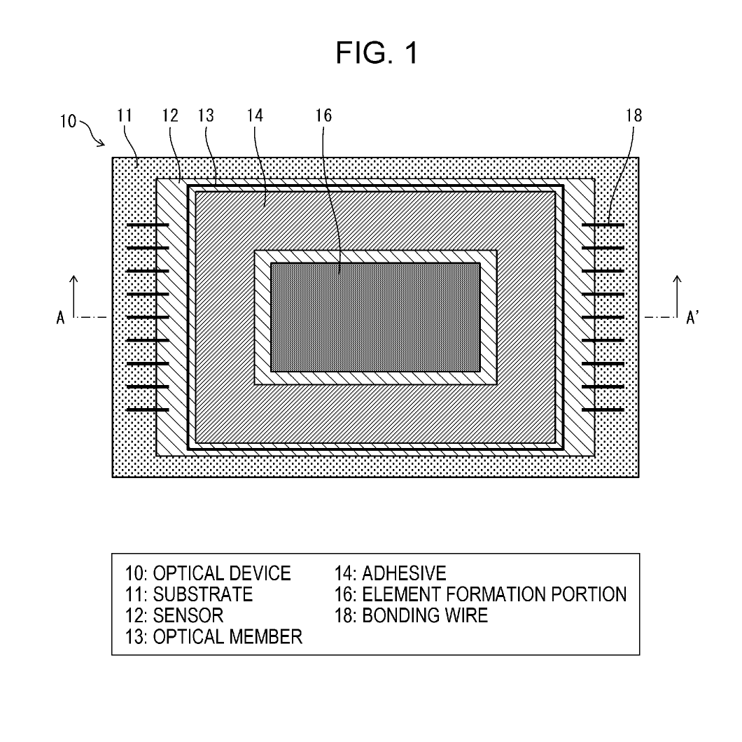

An embodiment of the present invention will be described in detail below with reference to FIGS. 1 to 4. In the drawings referenced to explain embodiments of the present invention, unless otherwise specified, the substrate side of an optical device is called the lower side, and the optical-member side of the optical device is called the upper side.

<Optical Device>

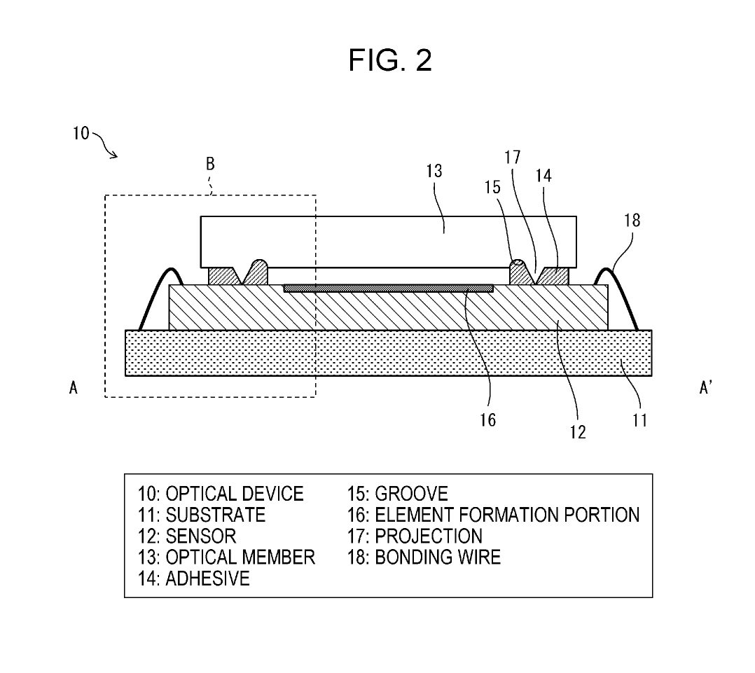

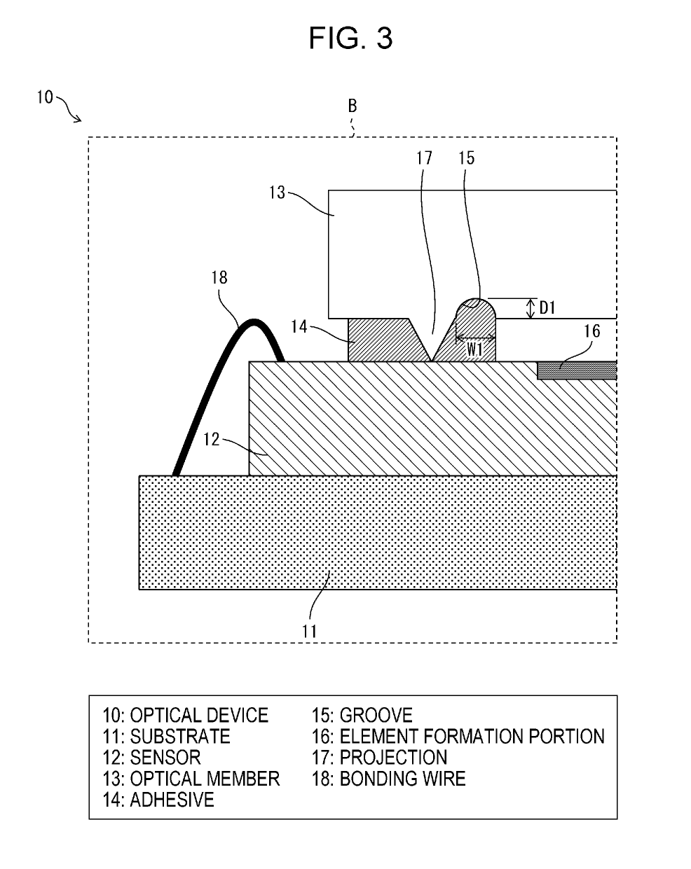

FIG. 1 is a plan view of an optical device 10 according to Embodiment 1 of the present invention. FIG. 2 is a sectional view taken along a line A-A′ in FIG. 1 when looking in a direction of arrow, and FIG. 3 is an enlarged view of a region B in FIG. 2.

In one embodiment of the present invention, the optical device 10 includes a substrate 11, a sensor 12 having an upper surface in which an element formation portion 16 is formed, the element formation portion 16 including light receiving elements arranged therein to detect incident light, an optical member 13 guiding the light to the element formation portion 16, an adhesive 14 (first bonding material), and a groove 15 functioning as a leakage prevention mechanism.

The sensor 12 is mounted to the substrate 11, and the optical member 13 is arranged to face an upper surface of the sensor 12. The optical member 13 is an optically transparent member, and it is in the form of a flat plate, for example. The optical member 13 includes a projection 17 formed on at least part of its surface on the side closer to the sensor 12. The projection 17 contacts at least part of the upper surface of the sensor 12.

The adhesive 14 bonds a region in the upper surface of the sensor 12 other than effective ones of the light receiving elements in the element formation portion 16 and the surface of the optical member 13 on the side closer to the sensor 12. The adhesive 14 may be, for example, a material with properties having fluidity in a state prior to later-described curing, but being cured with lapse of time, irradiation of ultraviolet light, or another specific process. In such a case, the adhesive 14 may be a material that has fluidity when it is applied to the upper surface of the sensor 12 or the lower surface of the optical member 13, and that bonds the sensor 12 and the optical member 13 when it is cured with suitable one of the above-described processes.

Furthermore, the adhesive 14 is a light-shielding material. In a practical example, the color of the adhesive 14 is preferably black or navy blue. However, the adhesive 14 is not limited to the above-mentioned colors, and it may be a brown or translucent material.

The groove 15 is formed in the surface of the optical member 13 on the side closer to the sensor 12. The groove 15 has the function of preventing the adhesive 14 from overflowing onto the effective light receiving elements in the element formation portion 16 on the upper surface of the sensor 12.

In the element formation portion 16 of the sensor 12 in this embodiment, the light receiving elements are all the effective light receiving elements capable of detecting the incident light with, for example, application of voltage to detection elements, but the present invention is not limited to that case. Alternatively, some of the light receiving elements in the element formation portion 16 may be ineffective light receiving elements.

In the above alternative case, the sensor 12 detects only light incident on the effective light receiving elements, and does not detect light incident on the ineffective light receiving elements. Thus, the bonding between the sensor 12 and the optical member 13 may be effectuated with the adhesive 14 applied over the ineffective light receiving elements.

The sensor 12 further includes not-illustrated terminals on its upper surface outside the element formation portion 16. The sensor 12 and the optical member 13 are not bonded by the adhesive 14 at positions of the terminals, and the substrate 11 and the terminals are electrically connected by bonding wires 18.

As illustrated in FIG. 1, the optical device 10 is constituted by stacking the substrate 11, the sensor 12, and the optical member 13 in the mentioned order from below. The element formation portion 16 is formed on the upper surface of the sensor 12, and the adhesive 14 is applied to the surroundings of the element formation portion 16. The adhesive 14 bonds the upper surface of the sensor 12 and the lower surface of the optical member 13. Moreover, the substrate 11 and the terminals formed outside the element formation portion 16 in the sensor 12 are electrically connected by the bonding wires 18.

Although a flat-plate member having optical transparency is used as an example of the optical member 13 in this embodiment, the present invention is not limited to that case. In another example, the optical member 13 may be a lens or a member reflecting light.

In FIG. 1, since the optical member 13 has optical transparency, the adhesive 14 and the element formation portion 16 can be visually recognized from above in a way of seeing through the optical member 13.

<Groove in Optical Member>

FIG. 2 is a sectional view taken along a line A-A′ in FIG. 1 when looking in a direction of arrow. A-A′ denotes, as illustrated in FIG. 1, a linear line passing the substrate 11, the sensor 12, the optical member 13, the adhesive 14, the element formation portion 16, and the bonding wires 18. Unless otherwise specified, sectional views referenced below represent views sectioned at the same position as for the above-described sectional view taken along the line A-A′ when looking in the direction of arrow. FIG. 3 is an enlarged view of a region B in FIG. 2. The region B represents the vicinity of a position where the groove 15 and the projection 17 are provided.

As illustrated in FIGS. 2 and 3, the optical member 13 includes the groove 15 and the projection 17 in and on its surface facing the sensor 12. The groove 15 is formed at a position corresponding to a region outside the element formation portion 16 on the inner side than a position at which the adhesive 14 is applied when the optical member 13 is bonded.

When the adhesive 14 overflows toward the element formation portion 16 until reaching the vicinity of the groove 15, it is sucked up into the groove 15 due to the capillary phenomenon. Therefore, the adhesive 14 can be suppressed from reaching the element formation portion 16. Thus, even if an amount of the adhesive 14 increases to some extent, the adhesive 14 is less apt to enter a region above the effective light receiving elements in the element formation portion 16.

A width of the groove 15, i.e., a distance W1 from one end to the other end of the groove 15 in the same plane as the lower surface of the optical member 13, is 0.01 mm, for example. A depth D1 of the groove 15, i.e., a distance between the lower surface of the optical member 13 and the bottom of the groove 15, is 0.01 mm, for example. However, dimensions of the groove are not limited to the above-mentioned values.

If the width of the groove 15 is too large, there is a possibility that the above-described capillary phenomenon does not occur. On the other hand, if the width of the groove 15 is too small, there is a possibility that the adhesive 14 is not sucked up into the groove 15. The width and the depth of the groove 15 are preferably determined with intent to reduce the above-mentioned possibilities.

<Projection>

The projection 17 is provided on the surface of the optical member 13 facing the sensor 12 outside the position corresponding to the element formation portion 16. A lower end of the projection 17 contacts the upper surface of the sensor 12 outside the element formation portion 16. Thus, a clearance between the sensor 12 and the optical member 13 can be held in accordance with the height of the projection 17.

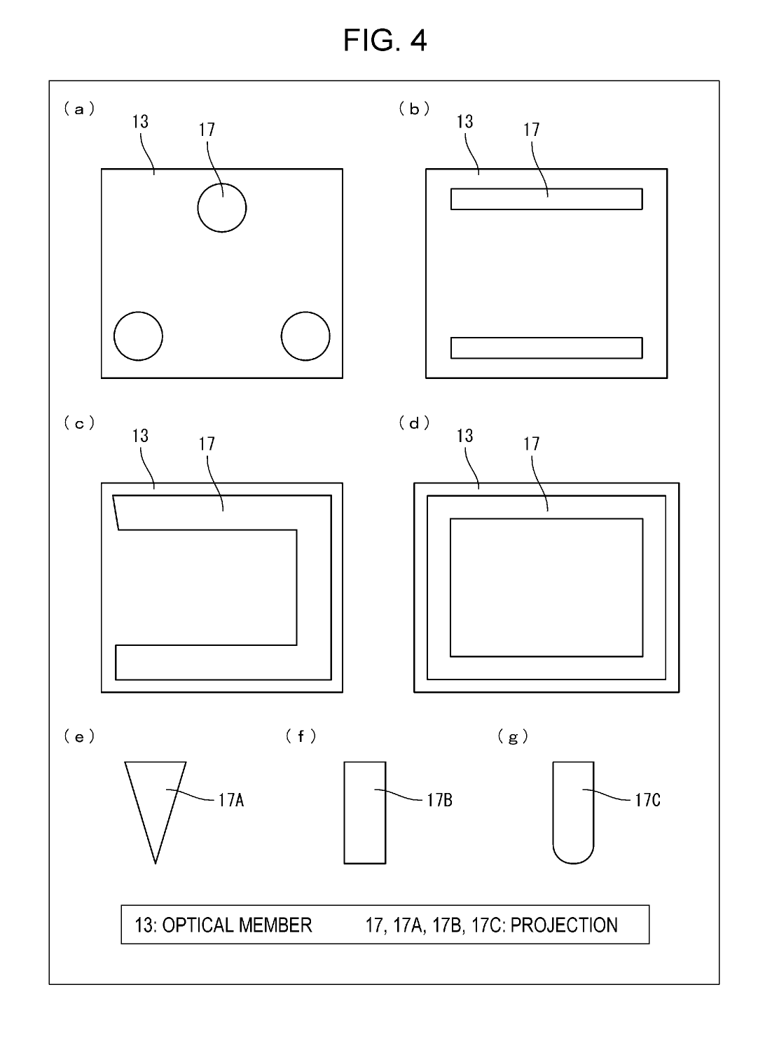

FIG. 4 is a schematic view illustrating examples of the arranged position and the shape of the projection 17 in this embodiment. In FIG. 4, (a) to (d) illustrate position examples of the projection 17 provided on the optical member 13. The projection 17 is provided, for example, at three positions illustrated in FIG. 4(a), in the form of two linear lines illustrated in FIG. 4(b), in substantially the C (channel)-like form illustrated in FIG. 4(c), or the □ (frame)-like form illustrated in FIG. 4(d). However, the present invention is not limited to those cases, and the projection 17 is just required to be provided in a layout corresponding to at least apexes of an N-sided polygon (3≤N), or a layout corresponding to at least one side of the N-sided polygon and one point (the one point being different from both ends of the one side). With the above-described layout, the clearance between the sensor 12 and the optical member 13 can be held constant at any point.

In FIG. 4, (e) to (g) illustrate shape examples of the projection 17. The projection 17 may have various shapes, such as a triangular shape in cross-section (e.g., a conical shape) represented by a projection 17A in FIG. 4(e), a rectangular shape in cross-section (e.g., a cylindrical shape) represented by a projection 17B in FIG. 4(f), and a shape corresponding to a half ellipse in cross-section (e.g., a bell shape) represented by a projection 17C in FIG. 4(g). However, the present invention is not limited those cases, and the projection 17 may have any suitable shape insofar as the shape is not deformed even under application of vertical force. The height of the projection 17 is 0.02 mm, for example, but it is not limited to such a value.

This embodiment represents an example in which the clearance between the sensor 12 and the optical member 13 is held in accordance with the height of the projection 17, but the present invention is not limited that example. In another example, the clearance between the sensor 12 and the optical member 13 may be held by mixing filler into the adhesive 14. With that feature, the spacing between the sensor 12 and the optical member 13 can be designed in accordance with the particle size of the filler without providing the projection 17. In this case, the clearance between the sensor 12 and the optical member 13 can be held constant at any point by applying the adhesive 14 to the surroundings of the element formation portion 16, and by bonding the sensor 12 and the optical member 13 in the layout corresponding to at least apexes of an N-sided polygon (3≤N), or the layout corresponding to at least one side of the N-sided polygon and one point (the one point being different from both ends of the one side). The particle size of the filter is 0.02 mm, for example, but it is not limited to such a value.

Furthermore, the groove 15 can be formed in shapes illustrated in FIGS. 4(e) to 4(g). More specifically, the groove 15 may have various shapes, such as a V-shape in conformity with the shape of the projection 17A illustrated in FIG. 4(e), a squarely-recessed shape in conformity with the projection 17B illustrated in FIG. 4(f), and a U-shape in conformity with the shape of the projection 17C illustrated in FIG. 4(g). The shape of the groove 15 is not limited to the above-described examples, and the groove 15 may have any suitable shape insofar as the adhesive 14 can be sucked up into the groove 15 due to the capillary phenomenon.

### Embodiment 2

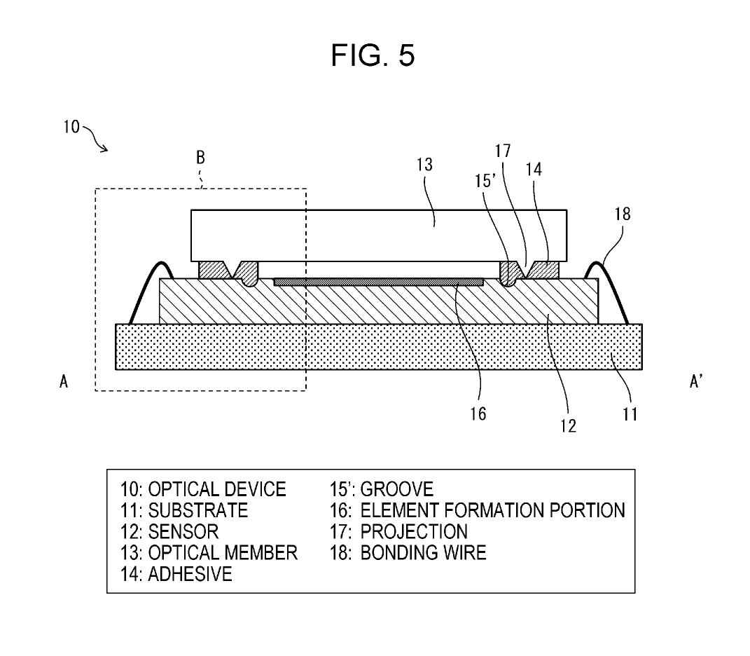

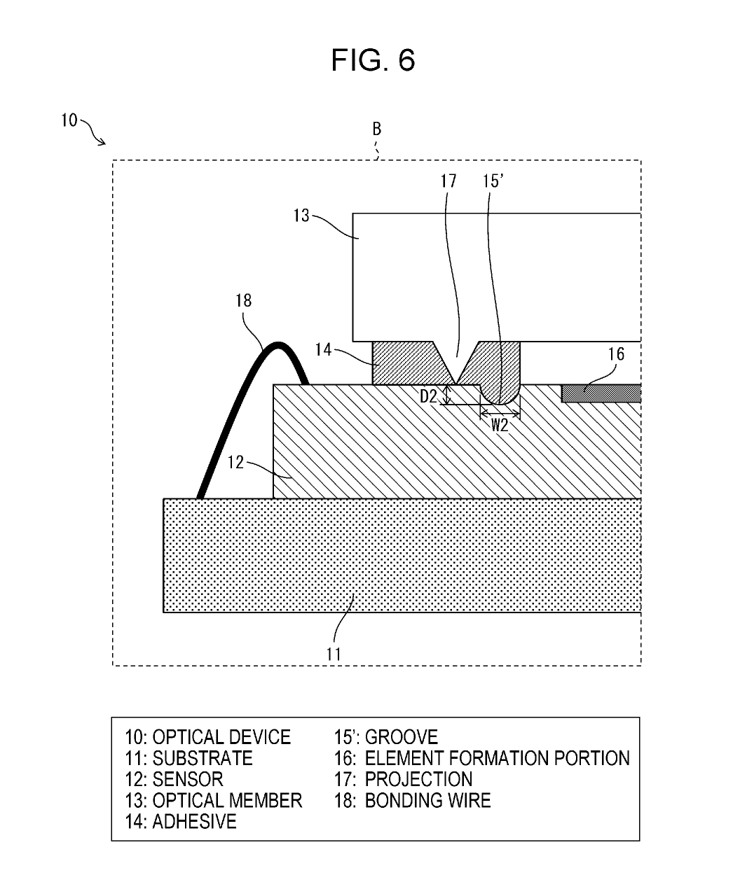

Another embodiment of the present invention will be described with reference to FIGS. 5 and 6. For convenience of explanation, components having the same functions as the components described in the above embodiment are denoted by the same reference signs, and description of those components is omitted.

<Groove in Sensor>

FIG. 5 is a sectional view of an optical device 10 according to Embodiment of the present invention. FIG. 6 is an enlarged view of a region B in FIG. 5.

The optical device 10 according to this embodiment includes a substrate 11, a sensor 12 having an upper surface in which an element formation portion 16 is formed, the element formation portion 16 including light receiving elements arranged therein, an optical member 13 guiding light to the element formation portion 16, an adhesive 14 (first bonding material), and a groove 15′ functioning as a leakage prevention mechanism.

Comparing with Embodiment 1, the optical device 10 of this embodiment is different in position at which the groove functioning as the leakage prevention mechanism is formed.

The sensor 12 includes the groove 15′ formed in its upper surface in a region other than the effective light receiving elements in the element formation portion 16. As illustrated, by way of example, in FIGS. 5 and 6, the groove 15′ is formed in a surface of the sensor 12, the surface facing the optical member 13, at a position corresponding to a region outside the element formation portion 16 on the inner side than a position at which the adhesive 14 is applied when the optical member 13 is bonded.

When the adhesive 14 overflows toward the element formation portion 16 until reaching the vicinity of the groove 15′, it falls into the groove 15′. Therefore, the adhesive 14 having overflowed can be suppressed from reaching the element formation portion 16. Thus, even if an amount of the adhesive 14 increases to some extent, the adhesive 14 is less apt to enter a region above the effective light receiving elements in the element formation portion 16. A width and a depth of the groove 15′ are each 0.001 mm, for example, but they are not limited to such a value. If the width of the groove 15′ is too large, there is a possibility that the above-described capillary phenomenon does not occur. On the other hand, if the width of the groove 15′ is too small, there is a possibility that the adhesive 14 is not sucked up into the groove 15′. The width and the depth of the groove 15′ are preferably determined with intent to reduce the above-mentioned possibilities. The groove 15′ can be formed in the sensor 12 by a method of performing etching or cutting with a dicing machine to form the groove 15′ at the same time as in an etching step or a dicing step on a wafer of the sensor 12, but the forming method is not limited to such an example.

### Embodiment 3

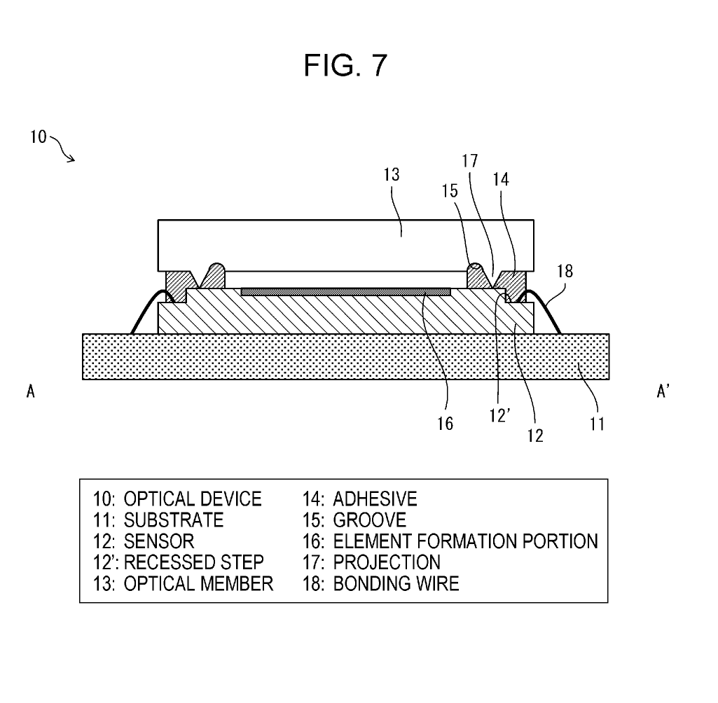

Still another embodiment of the present invention will be described with reference to FIG. 7. For convenience of explanation, components having the same functions as the components described in the above embodiments are denoted by the same reference signs, and description of those components is omitted.

<Sensor Including Terminal in Recessed Step>

FIG. 7 is a sectional view of an optical device according to this embodiment.

In this embodiment, the optical device 10 includes a substrate 11, a sensor 12 having an upper surface in which an element formation portion 16 is formed, the element formation portion 16 including light receiving elements arranged therein, an optical member 13 guiding light to the element formation portion 16, an adhesive 14 (first bonding material), and a groove 15 functioning as a leakage prevention mechanism.

Comparing with Embodiment 1, the optical device 10 of this embodiment is different in that the sensor 12 further includes a recessed step 12′ and a terminal is provided on the recessed step 12.

The sensor 12 includes the recessed step 12′ formed in at least part of its upper surface outside the element formation portion 16. The terminal is provided on the recessed step 12′ and is connected to a bonding wire 18. Thus, the substrate 11 and the sensor 12 are electrically connected to each other.

As illustrated in FIG. 7, the recessed step 12′ may be formed, for example, along each of at least two opposing sides among peripheral edges of the sensor 12. The recessed step 12′ is not limited to that example, and it may be designed to be formed only at a position where the bonding wire 18 is disposed. The recessed step 12′ may be formed by processing that is performed, for example, in an etching step for a wafer of the sensor 12. In that case, the terminal can be provided by rewiring a metal wiring line on the recessed step 12′.

By rewiring the metal wiring line on the recessed step 12′ as described above, the terminal can be provided at a position where a significant influence hardly occurs on bonding and mounting of the optical member 13 to the sensor 12. Furthermore, as illustrated in FIG. 7, the recessed step 12′ can be formed under the optical member 13. Thus, the terminal is not required to be provided on the outer side than the position to which the adhesive 14 is applied, and the terminal can be provided closer to the element formation portion 16. As a result, the size of the sensor 12 can be further reduced.

### Embodiment 4

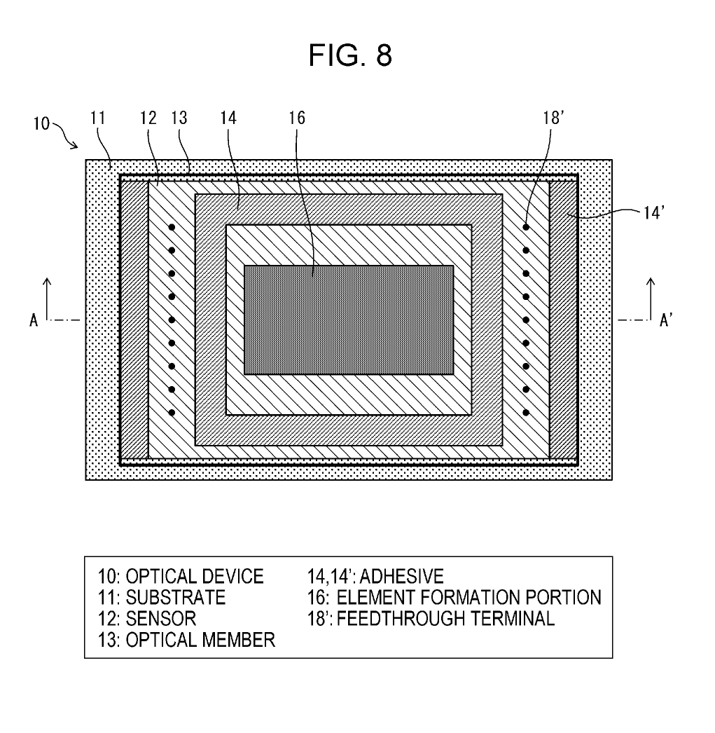

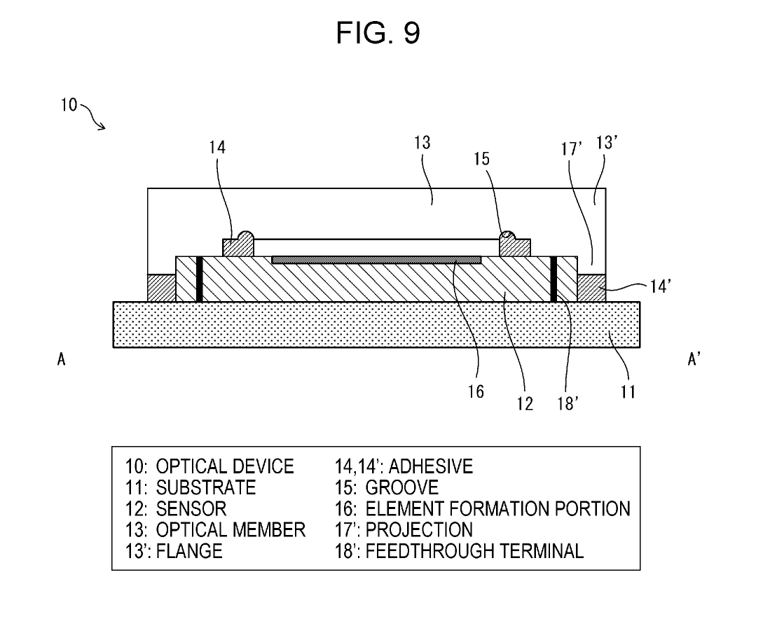

Still another embodiment of the present invention will be described with reference to FIGS. 8 and 9. For convenience of explanation, components having the same functions as the components described in the above embodiments are denoted by the same reference signs, and description of those components is omitted.

FIG. 8 is a plan view of an optical device 10 according to this embodiment, and FIG. 9 is a sectional view taken along a line A-A′ in FIG. 8 when looking in a direction of arrow.

In this embodiment, the optical device 10 includes a substrate 11, a sensor 12 having an upper surface in which an element formation portion 16 is formed, the element formation portion 16 including light receiving elements arranged therein, an optical member 13 guiding light to the element formation portion 16, an adhesive 14 (first bonding material), and a groove 15 functioning as a leakage prevention mechanism.

Comparing with Embodiment 1, the optical device 10 of this embodiment is different in the following three points.

<Feedthrough Terminal>

First, the sensor 12 includes a feedthrough terminal 18′ in its upper surface in a region other than the element formation portion 16, the feedthrough terminal 18′ penetrating through the sensor 12 from the upper surface. The feedthrough terminal 18′ is electrically connected to the substrate 11, thus establishing electrical connection between the substrate 11 and the sensor 12. As illustrated in FIG. 8, the feedthrough terminal 18′ may be provided in plural number around the element formation portion 16 in the sensor 12 along each of two opposing sides.

As illustrated in FIG. 9, the feedthrough terminal 18′ may be provided right under the optical member 13. This layout eliminates the necessity of a step of laying a wiring line for the connection between the substrate 11 and the sensor 12 in a way of not interfering with the adhesive 14. Accordingly, design and manufacturing of the optical device 10 are facilitated. Moreover, there is no necessity of providing a terminal for a wiring line, which electrically connects the substrate 11 and the sensor 12, on the substrate 11 outside a position where the sensor 12 is mounted. Thus, a mounting area of the optical device 10 can be reduced, and the device size can be further reduced.

<Projecting Portion>

Secondly, the optical member 13 includes a projecting portion 17′ that projects from a flange 13′ of the optical member 13. The projecting portion 17′ projects up to a position around a lateral surface of the sensor 12. Here, the flange 13′ represents a portion of the optical member 13 around an effective region thereof, i.e., a portion of the optical member 13 positioned outside a region right above the element formation portion 16.

As illustrated in FIG. 9, the flange 13′ of the optical member 13 is formed to extend outward beyond the lateral surface of the sensor 12. The projecting portion 17′ is formed to project downward from the flange 13′ along the lateral surface of the sensor 12. The projecting portion 17′ may be positioned in contact with the sensor 12 or adjacent to the sensor 12 without contacting it.

With the above-described configuration, if the optical member 13 is displaced in the horizontal direction relative to the upper surface of the sensor 12 when the optical member 13 is mounted, the projecting portion 17′ comes into contact with the lateral surface of the sensor 12. Therefore, a position deviation of the optical member 13 relative to the upper surface of the sensor 12 in the horizontal direction is reduced. As a result, the optical member 13 can be more precisely mounted onto the sensor 12.

In this embodiment, the projecting portion 17′ is formed in contact with or adjacent to an entire periphery of the sensor 12, and all terminals of the sensor 12 are constituted by the feedthrough terminal 18. However, the present invention is not limited to that case. For example, some of the terminals may be connected using the bonding wire 18 (see FIG. 1). In such an example, a region where the bonding wire 18 is arranged can be secured by forming the flange 13′ and the projecting portion 17′ to be not positioned in part of the optical member 13. Stated in another way, in the above example, the flange 13′ and the projecting portion 17′ are preferably formed in shapes not interfering with the bonding wire 18 in a state after bonding the sensor 12 and the optical member 13.

<Optical Member Bonded to Component Other than Sensor>

Thirdly, the optical member 13 is further bonded to the other component of the optical device 10 than the sensor 12 with an adhesive 14′ (second bonding material) interposed therebetween. For example, as illustrated in FIG. 9, a lower end of the projecting portion 17′ of the optical member 13 is bonded to the substrate 11 with the adhesive 14′ interposed therebetween. The adhesive 14′ may be made of the same material as that of the adhesive 14 or a different material. Although FIG. 9 illustrates the optical device 10 in which the sensor 12 and the lower end of the projecting portion 17′ are further bonded to each other with the adhesive 14′ interposed therebetween. However, the present invention is not limited to such a case, and the adhesive 14′ may bond only the substrate 11 and the lower end of the projecting portion 17′.

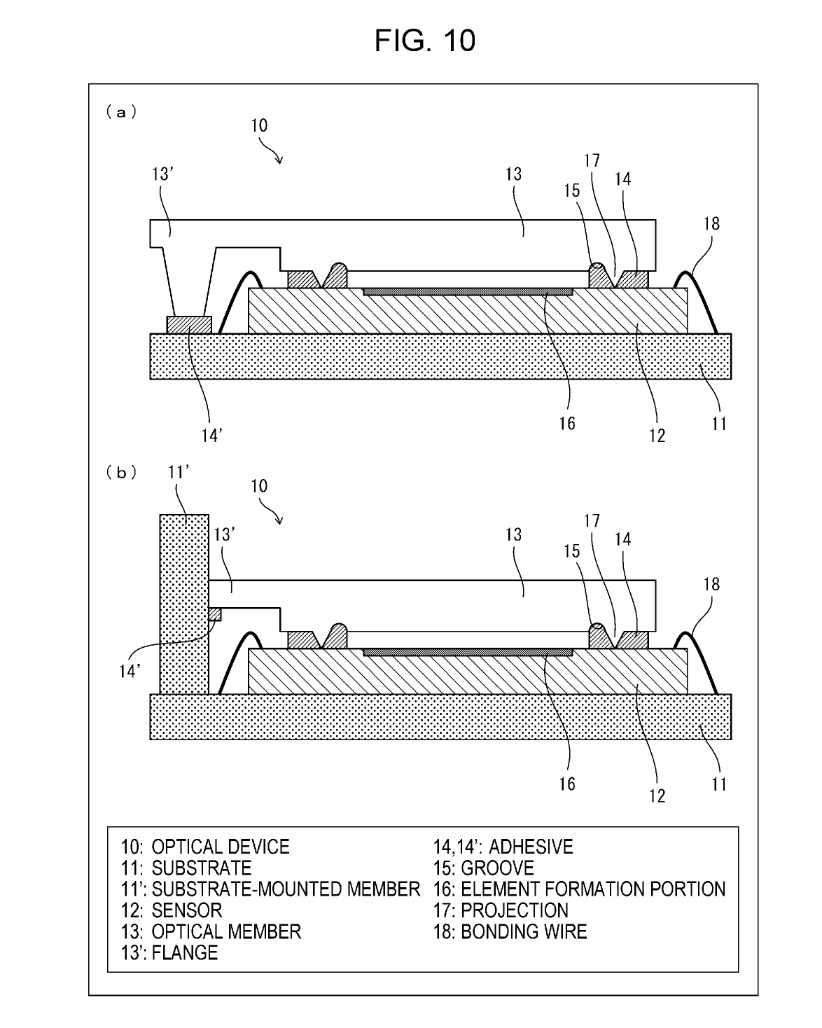

In addition, the configuration of bonding the optical member 13 to the other component than the sensor 12 with the adhesive 14′ interposed therebetween may be implemented as illustrated in FIG. 10.

As illustrated in FIG. 10(a), for example, the flange 13′ may be formed to extend beyond the bonding wire 18 toward the side opposite to the element formation portion 16, and the substrate 11 may be bonded to the flange 13′ with the adhesive 14′ interposed therebetween. Alternatively, as illustrated in FIG. 10(b), the flange 13′ may be formed to extend beyond the bonding wire 18 outward of the sensor 12, and a substrate-mounted member 11′, which is mounted to the substrate 11, may be bonded to the flange 13′ with the adhesive 14′ interposed therebetween. The substrate-mounted member 11′ may be, for example, a cover of the optical device 10 or an actuator for driving a drive mechanism (not illustrated) of the optical device 10, the drive mechanism being disposed above the optical member 13. However, the substrate-mounted member 11′ is not limited to such as example.

With the above-described configuration, the optical member 13 can be bonded to not only the sensor 12, but also any of the other various components. Therefore, the optical member 13 can be more firmly fixed in place. It is hence possible to reduce a position deviation of the optical member 13, and to more precisely design the optical device 10.

### Embodiment 5

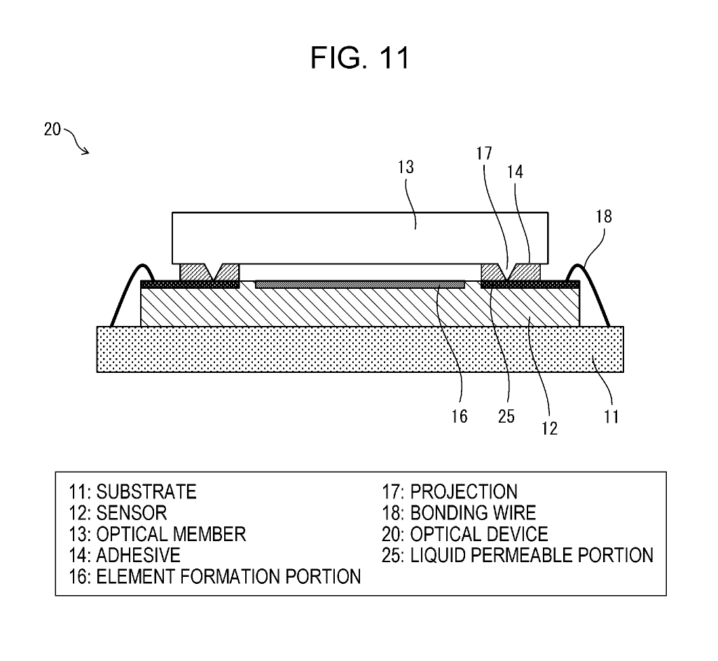

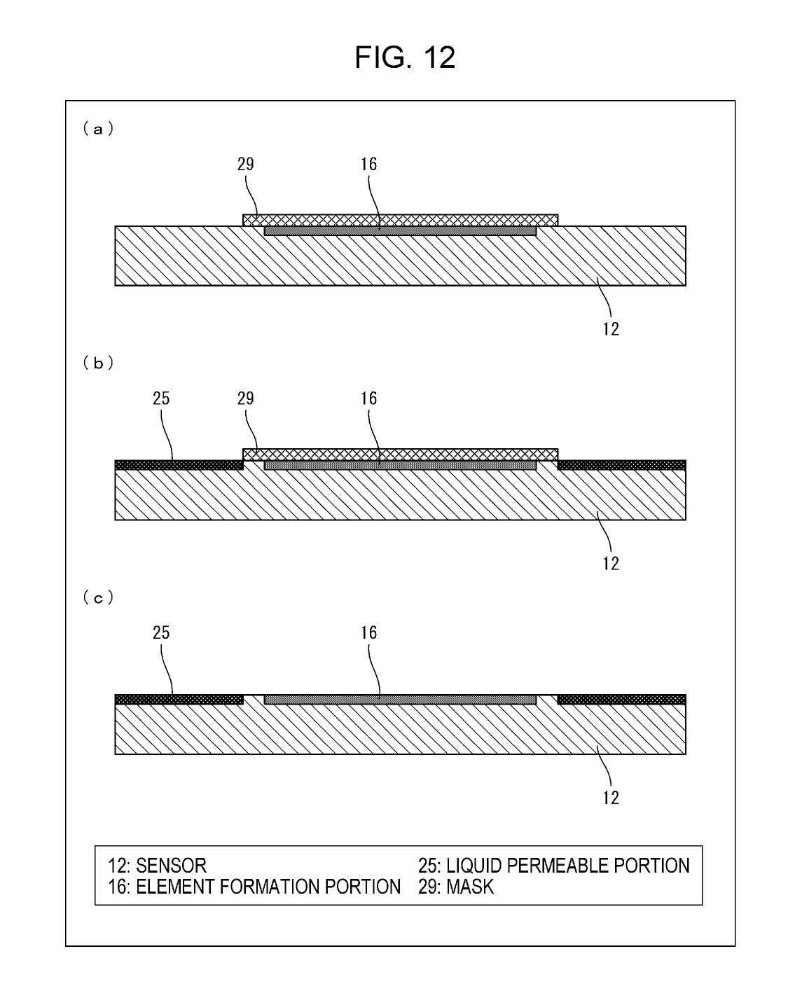

Still another embodiment of the present invention will be described with reference to FIGS. 11 and 12. For convenience of explanation, components having the same functions as the components described in the above embodiments are denoted by the same reference signs, and description of those components is omitted.

<Sensor Including Liquid Permeable Portion>

FIG. 11 is a sectional view of an optical device 20 according to Embodiment 5 of the present invention. The optical device 20 according to this embodiment includes a substrate 11, a sensor 12 having an upper surface in which an element formation portion 16 is formed, the element formation portion 16 including light receiving elements arranged therein, an optical member 13 guiding light to the element formation portion 16, an adhesive 14 (first bonding material), and a liquid permeable portion 25 functioning as a leakage prevention mechanism.

Comparing with the optical device 10 of Embodiment 1, the optical device 20 of this embodiment is different in that the liquid permeable portion 25 is specially formed instead of forming the groove that functions as the leakage prevention mechanism.

The liquid permeable portion 25 is formed in an upper surface of the sensor 12 in a region other than the effective light receiving elements in the element formation portion 16. The liquid permeable portion 25 is featured in providing higher affinity to the adhesive 14 than the upper surface of the sensor 12 in the region other than the liquid permeable portion 25.

As illustrated in FIG. 11, the liquid permeable portion 25 is formed in the upper surface of the sensor 12 outside the element formation portion 16 at a position spaced from the element formation portion 16. Because affinity between the liquid permeable portion 25 and the adhesive 14 is high, the adhesive 14 applied onto the liquid permeable portion 25 is kept staying on the liquid permeable portion 25. Thus, the adhesive 14 can be suppressed from overflowing to a region other than the liquid permeable portion 25, i.e., a region where affinity to the adhesive 14 is low, such as particularly a region including the effective light receiving elements in the element formation portion 16.

<Formation of Liquid Permeable Portion>

FIG. 12 is a schematic view illustrating steps of manufacturing the sensor 12 according to Embodiment 5 of the present invention, i.e., the sensor 12 including the liquid permeable portion 25.

Individual pieces of the sensors 12 each including the element formation portion 16 formed on its surface are obtained through an etching step and a dicing step. Then, as illustrated in FIG. 12(a), a mask 29 is formed on the upper surface of the sensor 12 to cover the element formation portion 16 and the vicinity thereof.

Thereafter, the sensor 12 is irradiated from above with argon plasma, oxygen plasma, or ozone UV (ultraviolet light), for example. As a result, a reforming process is performed on the upper surface of the sensor 12, and the liquid permeable portion 25 having higher affinity to the adhesive 14 is formed as illustrated in FIG. 12(b). However, the liquid permeable portion 25 is not formed at the position of the mask 29, i.e., in the element formation portion 16 and the vicinity thereof, because the irradiation is blocked by the mask 29.

Finally, the mask 29 is removed by performing treatment with an appropriate pharmaceutical such as an organic solvent. Through the above-described steps, the sensor 12 including the liquid permeable portion 25 formed therein can be manufactured. Although, in the above example, the mask 29 is formed over a region covering the entirety of the element formation portion 16, the present invention is not limited that example. In another example, the reforming process may be performed by forming the mask 29 only over the effective light receiving elements and the vicinity thereof in the element formation portion 16.

Although, in the above example, the reforming process is performed with the irradiation of, e.g., argon plasma, oxygen plasma, ozone UV, the present invention is not limited that example. Various types of known reforming processes can be optionally applied insofar as the process can form the liquid permeable portion 25 in which the affinity to the adhesive 14 is increased.

### Embodiment 6

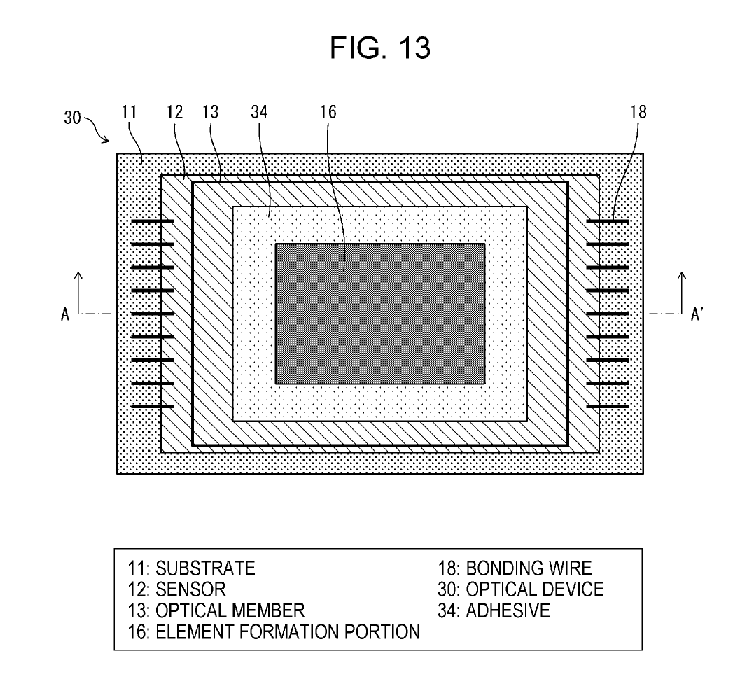

Still another embodiment of the present invention will be described with reference to FIGS. 13 to 16. For convenience of explanation, components having the same functions as the components described in the above embodiments are denoted by the same reference signs, and description of those components is omitted.

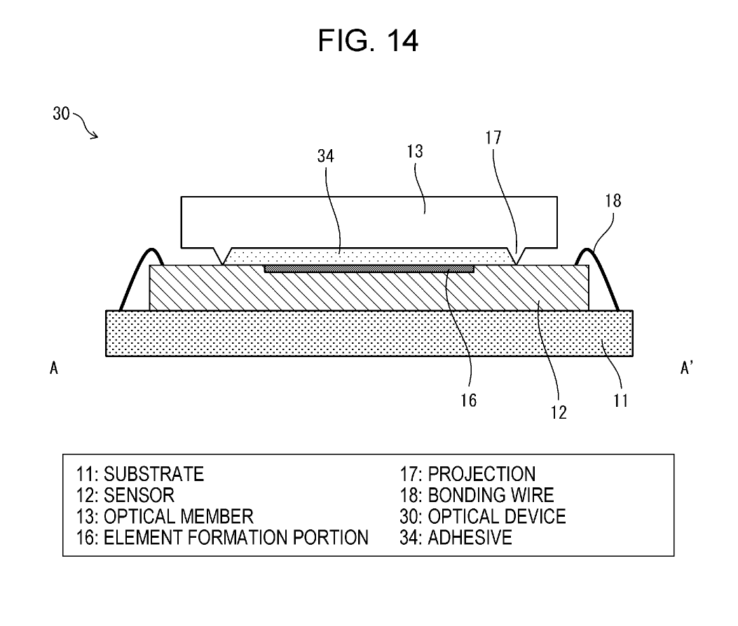

FIG. 13 is a plan view of an optical device 30 according to Embodiment 6 of the present invention, and FIG. 14 is a sectional view taken along a line A-A′ in FIG. 13 when looking in a direction of arrow.

The optical device 30 according to this embodiment includes a substrate 11, a sensor 12 having an upper surface in which an element formation portion 16 is formed, the element formation portion 16 including light receiving elements arranged therein, an optical member 13 guiding light to the element formation portion 16, and an adhesive 34 (first bonding material). The sensor 12 is mounted to the substrate 11, and the optical member 13 is arranged to face an upper surface of the sensor 12.

An adhesive 34 is a bonding material having optical transparency and having a lower refractive index than the optical member 13. The adhesive 34 is applied to be filled into a space between the sensor 12 and the optical member 13, thus bonding the sensor 12 and the optical member 13. In other words, the adhesive 34 bonds a region in the upper surface of the sensor 12 where the effective light receiving elements in the element formation portion 16 are formed and a surface of the optical member 13 on the side closer to the sensor 12.

As illustrated in FIG. 13, the optical device 30 is constituted by stacking the substrate 11, the sensor 12, and the optical member 13 in the mentioned order from below. The element formation portion 16 is formed on the upper surface of the sensor 12. As further illustrated in FIG. 14, the adhesive 34 fills the space between the sensor 12 and the optical member 13, and bonds the upper surface of the sensor 12 and the lower surface of the optical member 13. Moreover, the substrate 11 and terminals formed outside the element formation portion 16 in the sensor 12 are electrically connected by bonding wires 18.

The optical member 13 and the adhesive 34 have optical transparency. When looking at the optical device 30 from above, therefore, the element formation portion 16 can be visually recognized in a way of seeing through the optical member 13 and the adhesive 34, as illustrated in FIG. 13. However, the present invention is not limited to that example, and the adhesive 34 may have a light-shielding property like the adhesive 14 described in the above embodiment. Even in such a case, by applying the adhesive 34 in a state covering only part of the effective light receiving elements in the element formation portion 16, light detection can be performed using the light receiving elements not covered with the adhesive 34.

As illustrated in FIG. 14, the optical member 13 includes a projection 17 provided on at least part of the surface of the optical member 13 on the side closer to the sensor. The projection 17 contacts at least part of the upper surface of the sensor 12. As in the above embodiment, a lower end of the projection 17 contacts the upper surface of the sensor 12 outside the element formation portion 16. Thus, a clearance between the sensor 12 and the optical member 13 can be held in accordance with the height of the projection 17. The clearance between the sensor 12 and the optical member 13 can be held constant at any point with a configuration that the projection 17 is provided at least at positions corresponding to three or more points, or to one point and one or more sides.

Furthermore, in this embodiment, the projection 17 may be arranged in the □ (frame)-like form to surround the entire periphery of the element formation portion 16, thus providing the function of preventing the adhesive 34, which is filled between the sensor 12 and the optical member 13, to overflow outward of the sensor 12. Moreover, the groove and the liquid permeable portion described in the above embodiment may be formed between the periphery of the sensor 12 and the element formation portion 16 as the additional function of preventing the adhesive 34 from overflowing outward of the sensor 12.

<Refractive Index of Adhesive>

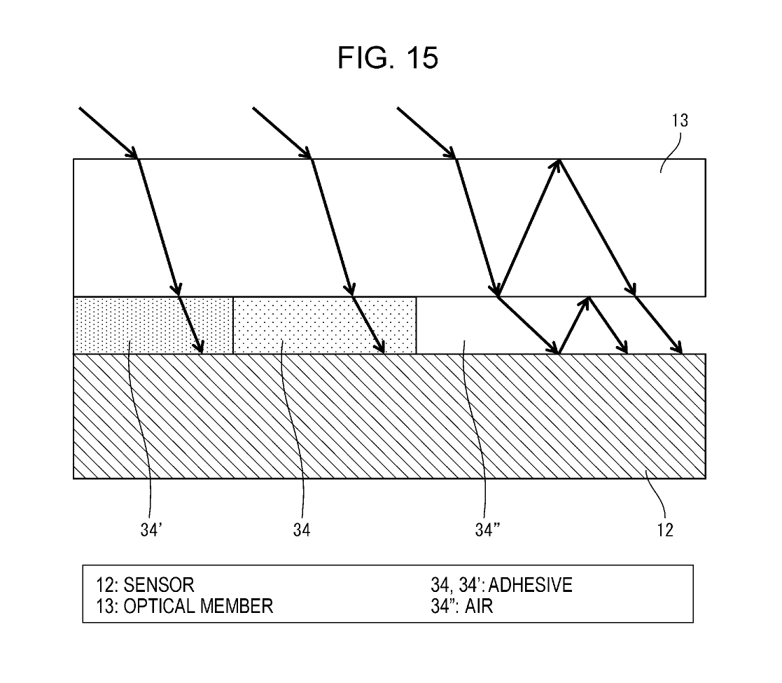

An influence caused by the adhesive 34 applied onto the element formation portion 16 will be described below with reference to FIG. 15.

FIG. 15 is a schematic view illustrating an influence on incident light, the influence being caused by difference in refractive index of the adhesive 34 in Embodiment 6 of the present invention.

To explain the above-mentioned influence, FIG. 15 illustrates not only the case that the adhesive 34 is applied between the sensor 12 and the optical member 13, but also the case that an adhesive 34′ having a higher refractive index than the adhesive 34 is applied therebetween. FIG. 15 further illustrates the case that no adhesive is applied, i.e., the case that the space between the sensor 12 and the optical member 13 is filled with air 34′. In FIG. 15, arrows denote paths of incident light toward the sensor 12.

The light incident on the optical member 13 passes through the optical member 13 and reaches the lower surface of the optical member 13. Reflection at the upper surface of the optical member 13 is not taken into consideration here. The light having reached the lower surface of the optical member 13 passes through the space between the sensor 12 and the optical member 13, and reaches the upper surface of the sensor 12.

<Occurrence of Reflection Between Sensor and Optical Member>

At a position where the space between the sensor 12 and the optical member 13 is filled with the air 34″, however, part of the light having reached the lower surface of the optical member 13 is reflected at the boundary between the optical member 13 and the air 34″. The reflected light is reflected again at the upper surface of the optical member 13, and advances toward the sensor 12. In addition, part of the light having reached the upper surface of the sensor 12 without being reflected at the boundary between the optical member 13 and the air 34″ is also reflected at the upper surface of the sensor 12 and is further reflected at the boundary between the optical member 13 and the air 34″, thus reaching the upper surface of the sensor 12 again. The occurrence of strong reflection at the boundary between the optical member 13 and the air 34″ is attributable to a large difference in refractive index between the optical member 13 and the air 34″.

If the light having been repeatedly reflected multiple times between the sensor 12 and the optical member 13 as described above enters the light receiving element of the sensor 12, false detection is caused because the light is detected at a position where the light is not to be normally detected. The false detection may bring about various failures, such as generation of a ghost image in a camera module or excessive detection in an optical detector.

A step of forming a reflection preventive film on the lower surface of the optical member 13 is required to avoid the above-described reflection. In the step of forming the reflection preventive film, foreign matters may come into the space between the sensor 12 and the optical member 13. This also causes a failure.

<Effects of Adhesive>

On the other hand, at a position where the adhesive 34 or the adhesive 34′ is applied between the sensor 12 and the optical member 13, reflection at the boundary between the optical member 13 and the adhesive 34 or at the boundary between the optical member 13 and the adhesive 34′ is reduced. Such reduction is attributable to the fact that the adhesive 34 and the adhesive 34′ have higher refractive indexes than the air 34″, namely that the difference in refractive index between each of the adhesive 34 and 34′ and the optical member 13 is comparatively small.

Thus, the light having been repeatedly reflected multiple times between the sensor 12 and the optical member 13 is suppressed from entering the light receiving element of the sensor 12 by filling the adhesive 34 or the adhesive 34′ between the sensor 12 and the optical member 13. As a result, light detection at the position where the light is not to be normally detected is suppressed. Furthermore, since the step of forming the reflection preventive film is not required, the manufacturing can be simplified. In addition, since the space between the sensor 12 and the optical member 13 is filled with the adhesive, no foreign matters come into the space, and the yield can be increased.

<Effects Obtained with Adhesive Having Smaller Refractive Index>

The path of the light passing through the optical member 13 and the paths of the lights passing through the adhesives 34 and 34′ are compared below. As illustrated in FIG. 15, a direction of the light passing through the adhesive 34 greatly changes at the boundary between the optical member 13 and the adhesive 34. This is because the refractive index of the adhesive 34 is smaller than that of the optical member 13. On the other hand, a direction of the light passing through the adhesive 34′ does not so greatly change at the boundary between the optical member 13 and the adhesive 34′. This is because the refractive index of the adhesive 34′ is greater than that of the adhesive 34 and is comparatively closer to that of the optical member 13.

As seen from the above discussion, when a lens, for example, is used as the optical member 13, convergence or divergence of light having passed through the lens can be more enhanced by using the adhesive 34 having a lower refractive index.

<Type of Lens>

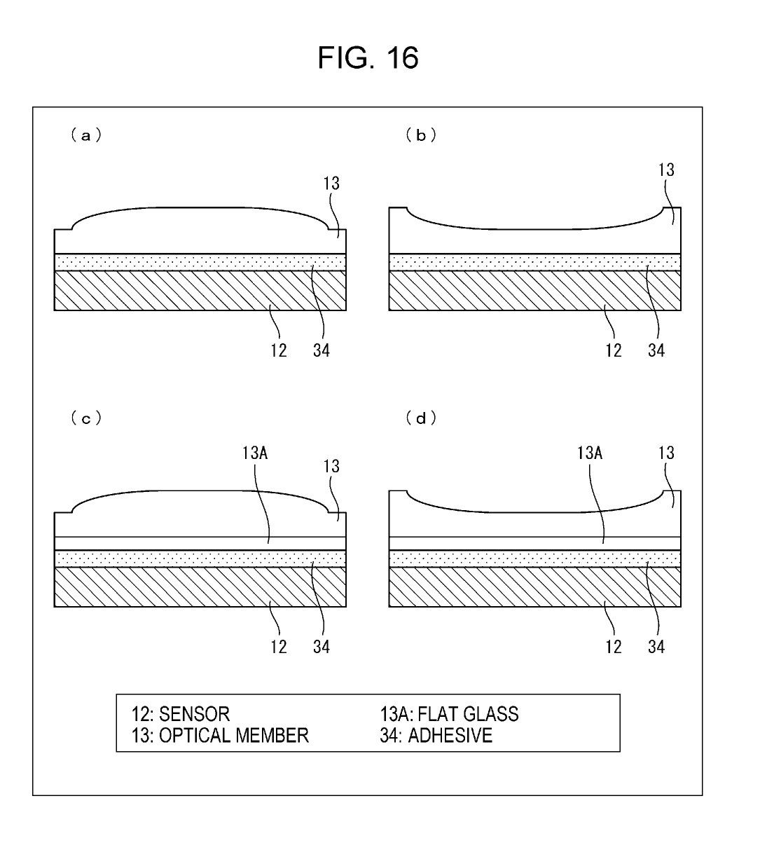

FIG. 16 illustrates exemplary configurations when a lens is used as the optical member 13. The optical member 13 may be a convex lens as illustrated in FIG. 16(a), or a concave lens as illustrated in FIG. 16(b). Moreover, as illustrated in FIGS. 16(c) and 16(d), a flat glass 13A having optical transparency may be disposed under the optical member 13 formed of a convex or concave lens, and the flat glass 13A may be bonded to the sensor 12 with the adhesive 34 interposed therebetween. The present invention is not limited to the above-described examples, and an LOC (Lens On Chip) lens may be used in another example. A material of the optical member 13 can also be selected from various known materials such as glass and resin. Which type of lens is to be used can be determined in design as required depending on the type of the optical device, etc.

<Type of Adhesive>

The adhesive 34 used in this embodiment can be selected from among various known bonding materials. The adhesive 34 may be optional one of bonding materials, such as an oily substance, a gel substance, a liquid substance, and a solid substance. Which one of those materials is to be used can be determined in design as required depending on the type of the optical device, etc. Furthermore, the adhesive 34 is preferably applied in a manner of not allowing a bubble to enter the adhesive 34. This makes it possible to avoid an unexpected influence on the incident light, such as change of an optical path, the change being caused by the fact that the light passing through the adhesive 34 advances through the bubble.

The adhesive 34 preferably has a thermal expansion coefficient comparable to those of the sensor 12 and the optical member 13. With that feature, even if the sensor 12 and the optical member 13 are thermally expanded due to heating of the optical device, etc., the adhesive 34 is able to deform following the expansion. Accordingly, internal stress can be prevented from acting on the adhesive 34, and the optical member 13 can be suppressed from peeling off from the sensor 12.

### Embodiment 7

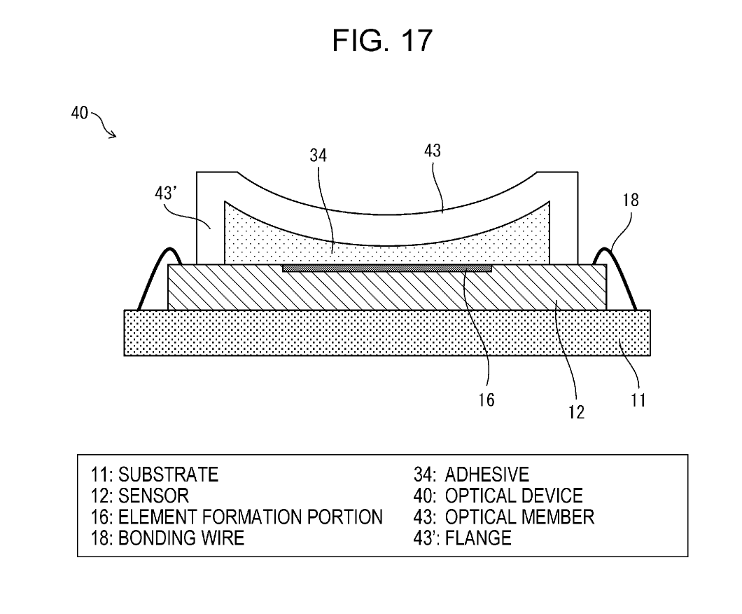

Still another embodiment of the present invention will be described with reference to FIG. 17. For convenience of explanation, components having the same functions as the components described in the above embodiments are denoted by the same reference signs, and description of those components is omitted.

FIG. 17 is a sectional view of an optical device 40 according to this embodiment.

The optical device 40 according to this embodiment includes a substrate 11, a sensor 12 having an upper surface in which an element formation portion 16 is formed, the element formation portion 16 including light receiving elements arranged therein, an optical member 43 guiding light to the element formation portion 16, and an adhesive 34 (first bonding material).

Comparing with the optical device 30 of Embodiment 6, the optical device 40 of this embodiment is different in using an optical member 43 instead of the optical member 13.

In the optical member 43, each of its surface facing the sensor 12 and its upper surface on the side opposite to the former surface has a curved-surface portion having a convex shape toward the sensor 12. Furthermore, the optical member 43 includes a flange 43′ formed around the optical member 43 and contacting the upper surface of the sensor 12. The flange 43′ is provided around the curved-surface portion of the optical member 43, and a lower end of the flange 43′ contacts the upper surface of the sensor 12. A thickness of the curved-surface portion on the inner side of the flange 43′ is substantially constant regardless of position. The adhesive 34 is filled in a space surrounded by the curved-surface portion, the flange 43′, and the sensor 12.

Therefore, a distance between the upper surface of the optical member 43 and the sensor 12 gradually increases from the center of the optical member 43 toward the periphery thereof. Because the adhesive 34 additionally has the optical properties as described above, the optical device 40 can be regarded in an optical sense as including, on the sensor 12, a concave lens in combination of the adhesive 34 and the optical member 43.

With the above-described configuration, even in the case of using an optical member having a small thickness deviation like the optical member 43, the optical device having optical properties similar to those of a lens can be realized. Accordingly, the optical device can be constituted using simple and inexpensive components. Hence reduction in manufacturing time and cost can be obtained.

Although, in this embodiment, the optical member 43 includes the flange 43′ contacting the sensor 12, the present invention is not limited to such a configuration. In another example, the optical member 43 including only the curved-surface portion (with omission of the flange 43′) may be bonded using the adhesive 34.

Recapitulation

An optical device 10, 20 according to a first aspect of the present invention includes a substrate 11, a sensor 12 having an upper surface in which an element formation portion 16 is formed, the element formation portion including light receiving elements arranged therein to detect light, an optical member 13 guiding the light to the element formation portion 16, a first bonding material (adhesive 14), and a leakage prevention mechanism (groove 15, groove 15′, liquid permeable portion 25), wherein the sensor 12 is mounted to the substrate 11, the optical member 13 is arranged to face an upper surface of the sensor 12, the first bonding material (adhesive 14) bonds a region in the upper surface of the sensor 12 other than the element formation portion 16 and a surface of the optical member 13 on the side closer to the sensor 12, and the leakage prevention mechanism (groove 15, groove 15′, liquid permeable portion 25) prevents the first bonding material (adhesive 14) from overflowing onto the light receiving elements in the element formation portion 16 on the upper surface of the sensor 12.

With the above features, even in the case of bonding the optical member to the upper surface of the sensor, the bonding material, e.g., the adhesive, can be prevented from overflowing onto the light receiving elements with the presence of the leakage prevention mechanism. It is, therefore, possible to such a phenomenon that incident light toward the light receiving elements is absorbed by the bonding material, and that the incident light does not reach the light receiving elements or reaches there in a reduced amount. Another phenomenon that an optical path is changed due to reflection or refraction occurred at the bonding material can also be suppressed. Thus, even when the optical member and the sensor are bonded to each other near the light receiving elements, the optical device can be realized in which the sensor has good quality in receiving the light.

Since the optical member and the sensor can be bonded to each other near the light receiving elements, a mounting area of the sensor and the optical member can be reduced, and hence a size of the optical device can be reduced. Furthermore, since there is no necessity of directly bonding the optical member and the substrate, deformations of the sensor and the optical member following change of the substrate are suppressed.

In an optical device 10 according to a second aspect of the present invention, on the basis of the above first aspect, the leakage prevention mechanism (groove 15, groove 15′, liquid permeable portion 25) may include a groove 15 formed in at least part of the surface of the optical member 13 on the side closer to the sensor 12.

With the above feature, the bonding material going to overflow onto the light receiving elements is sucked up into the groove formed in the optical member due to the capillary phenomenon. Therefore, the bonding material can be prevented from overflowing onto the light receiving elements.

In an optical device 10 according to a third aspect of the present invention, on the basis of the above first or second aspect, the leakage prevention mechanism (groove 15, groove 15′, liquid permeable portion 25) may include a groove 15′ formed in the upper surface of the sensor 12 in at least part of the region other than the light receiving elements in the element formation portion 16.

With the above feature, the bonding material going to overflow falls into the groove formed in the sensor. Therefore, the bonding material can be prevented from overflowing onto the light receiving elements.

In an optical device 20 according to a fourth aspect of the present invention, on the basis of the above first to third aspects, the leakage prevention mechanism (groove 15, groove 15′, liquid permeable portion 25) may include a liquid permeable portion 25 that is formed in the upper surface of the sensor 12 in at least part of the region other than the element formation portion 16, and that has affinity to the first bonding material (adhesive 14) higher than affinity of the element formation portion 16 to the first bonding material (adhesive 14).

With the above feature, the bonding material is more apt to stay in the liquid permeable portion formed in the sensor, and is suppressed from flowing toward the light receiving elements. Therefore, the bonding material can be prevented from overflowing onto the light receiving elements.

In an optical device 10, 20 according to a fifth aspect of the present invention, on the basis of the above first to fourth aspects, the first bonding material (adhesive 14) may have a light-shielding property.

With the above feature, the light going to enter the light receiving elements is suppressed from being reflected or scattered by the bonding material. Accordingly, changes of the optical path and the light amount are less apt to occur, and reliability of light detection by the sensor is improved.

In an optical device 10, 20 according to a sixth aspect of the present invention, on the basis of the above first to fifth aspects, the first bonding material (adhesive 14) may contain filler.

With the above feature, a clearance between the sensor and the optical member can be held constant in accordance with the particle size of the filler. Thus, the optical member can be more precisely attached to the sensor.

In an optical device 10, 20 according to a seventh aspect of the present invention, on the basis of the above first to sixth aspects, the optical member 13 may include a projection 17 on at least part of the surface of the optical member on the side closer to the sensor 12, and the projection 17 may contact at least part of the upper surface of the sensor 12.

With the above features, the clearance between the sensor and the optical member can be held constant in accordance with the height of the projection. Thus, the optical member can be more precisely attached to the sensor.

In an optical device 10, 20 according to an eighth aspect of the present invention, on the basis of the above first to seventh aspects, the sensor 12 may include a terminal provided in the upper surface of the sensor outside the element formation portion 16, the sensor 12 and the optical member 13 may not be bonded at a position of the terminal by the first bonding material (adhesive 14), and the substrate 11 and the terminal may be electrically connected.

If the bonding material is present on the terminal, wiring cannot be performed on the terminal. If the bonding material is applied after performing the wiring, there is a risk that wiring lines may be damaged or cut by the bonding material. With the above features, wiring lines for connection between the substrate and the sensor can be disposed out of interference with the bonding material. Accordingly, design and manufacturing are facilitated, and reliability of the electrical connection is improved.

In an optical device 10, 20 according to a ninth aspect of the present invention, on the basis of the above eighth aspect, the sensor 12 may include a recessed step 12′ formed in at least part of the upper surface of the sensor outside the element formation portion 16, and the terminal may be provided on the recessed step 12′.

With the above features, by rewiring a metal wiring line on the recessed step, the terminal can be provided at a position where an influence hardly occurs on mounting of the optical member. Therefore, the wiring lines for connection between the substrate and the sensor can be more easily disposed out of interference with the bonding material, whereby design and manufacturing are further facilitated. Moreover, the terminal can be provided on the inner side in comparison with the case not including the recessed step. In other words, the terminal can be provided closer to the element formation portion of the sensor. As a result, the size of the sensor can be reduced, and the size of the optical device can be further reduced.

In an optical device 10, 20 according to a tenth aspect of the present invention, on the basis of the above first to seventh aspects, the sensor 12 may include a feedthrough terminal 18′ penetrating through the sensor 12 from the upper surface of the sensor 12 in the region outside the element formation portion 16, and the substrate 11 and the feedthrough terminal 18′ may be electrically connected.

With the above features, the electrical connection between the substrate and the sensor is established through the feedthrough terminal. Therefore, a step of disposing the wiring lines for the connection between the substrate and the sensor in a way out of interference with the bonding material is not required. Accordingly, design and manufacturing are facilitated. Moreover, the terminals for wiring are not required to be provided on the substrate in a region outside the position where the sensor is mounted. As a result, a mounting area can be reduced, and the size of the optical device can be further reduced.

In an optical device 10, 20 according to an eleventh aspect of the present invention, on the basis of the above first to tenth aspects, the optical member 13 may include a projecting portion 17′ that projects around an effective region of the optical member 13 (namely, from a flange 13′) up to a position around a lateral surface of the sensor 12.

With the above feature, the projecting portion of the optical member mounted onto the sensor can be positioned in contact with or adjacent to the lateral surface of the sensor. Therefore, positioning of the optical member relative to the upper surface of the sensor in a horizontal direction is facilitated, and a position deviation of the optical member is easily reduced. Hence the optical member can be more precisely mounted onto the sensor.

An optical device 30, 40 according to a twelfth aspect of the present invention includes a substrate 11, a sensor 12 having an upper surface in which an element formation portion 16 is formed, the element formation portion including light receiving elements arranged therein to detect light, an optical member 13, 43 guiding the light to the element formation portion 16, and a first bonding material (adhesive 34), wherein the sensor 12 is mounted to the substrate 11, the optical member 13, 43 is arranged to face an upper surface of the sensor 12, and the first bonding material (adhesive 34) bonds a region in the upper surface of the sensor 12 where the element formation portion 16 is formed and a surface of the optical member 13, 43 on the side closer to the sensor 12.

With the above features, the optical member can be mounted onto the sensor by directly bonding the light receiving elements and the optical member. Thus, a mounting area of the sensor and the optical member can be reduced, and the size of the optical device can be reduced. Furthermore, since there is no necessity of directly bonding the optical member and the substrate, the sensor and the optical member are suppressed from being deformed following change of the substrate.

Moreover, since the bonding material is intentionally disposed on the light receiving elements, there is no necessity of taking into account overflow of the bonding material onto the sensor, and the leakage prevention mechanism for preventing overflow of the bonding material is no longer required. Accordingly, comparing with the case of providing the leakage prevention mechanism, design of the optical device is simplified, and reduction in cost and manufacturing time can be realized.

In addition, since the bonding material is intentionally disposed on the light receiving elements, there is no possibility that foreign matters having entered between the sensor and the optical device come into contact with the light receiving elements. Accordingly, unexpected image-capturing of the foreign matters and damage of the light receiving elements caused by the foreign matters can be suppressed.

In an optical device 30, 40 according to a thirteenth aspect of the present invention, on the basis of the above twelfth aspect, the first bonding material (adhesive 34) may have optical transparency.

As a position where the bonding material is applied, a difference in refractive index between the optical member and the bonding material is smaller than that between the optical member and air. Accordingly, at the position where the bonding material is applied, reflection of light at the boundary at which the optical member and the bonding material contact with each other is reduced.

With the above feature, a phenomenon that light having passed through the optical member enters the light receiving elements after being reflected multiple times in the above-mentioned space is reduced, and the occurrence of a ghost is suppressed. Therefore, a process of forming a reflection preventive film on the optical member to prevent the occurrence of the ghost is not required. Furthermore, it is possible to design the bonding material to have the function as the optical member at the same time, and to perform various designs without requiring the optical member having a complicated structure.

In an optical device 30, 40 according to a fourteenth aspect of the present invention, on the basis of the above thirteenth aspect, the first bonding material (adhesive 34) may be filled between the sensor 12 and the optical member 13, 43.

With the above feature, the above-mentioned space is completely filled with the bonding material. Therefore, optical properties in the space become uniform, and the path of the light having passed through the optical member, etc. can be easily estimated. Hence design of the optical device is facilitated. Furthermore, since the bonding material covers an entire region above the light receiving elements, the light having been reflected multiple times in the above-mentioned space is more reliably prevented from entering the light receiving elements, and the occurrence of the ghost is further suppressed. Moreover, since foreign matters can be surely avoided from coming into the above-mentioned space, attachment of the foreign matters to the light receiving elements can be more reliably prevented.

In an optical device 30, 40 according to a fifteenth aspect of the present invention, on the basis of the above thirteenth or fourteenth aspect, a refractive index of the first bonding material (adhesive 34) may be lower than a refractive index of the optical member 13, 43.

With the above feature, when the optical member is a lens, for example, the bonding material can be designed in a way of positively exhibiting the function as a lens. Therefore, the optical member providing high convergence or divergence of light can be realized without requiring a component that is difficult to design and is expensive, such as a lens having a large thickness deviation.

In an optical device 30, 40 according to a sixteenth aspect of the present invention, on the basis of the above twelfth to fifteenth aspects, the first bonding material (adhesive 34) may be one among an oily substance, a gel substance, a liquid substance, and a solid substance.

With the above feature, a material suitable as the bonding material can be variously changed depending on the types and usages of the sensor and the optical device used.

In an optical device 10, 20, 30, 40 according to a seventeenth aspect of the present invention, on the basis of the above first to sixteenth aspects, the optical member 13 may be further bonded to a component of the optical device 10, 20, 30, 40 other than the sensor 12 with a second bonding material (adhesive 14′) interposed therebetween.

With the above feature, the optical member can be bonded to not only the sensor, but also another component of the optical device. Therefore, the optical member can be more firmly fixed. As a result, a position deviation of the optical member is reduced, and the optical device can be more precisely designed.

The present invention is not limited to the above-described embodiments, and the present invention can be variously modified within the scope defined in Claims. Embodiments obtained by optionally combining the technical means disclosed in the different embodiments also fall within the technical scope of the present invention. In addition, novel technical features can be obtained by combining the technical means disclosed in the embodiments.

### REFERENCE SIGNS LIST

10, 20, 30, 40 optical device
11 substrate
11′ substrate-mounted member
12 sensor
13, 43 optical member
13′, 43′ flange
13A flat glass
14, 14′, 34, 34′ adhesive
15, 15′ groove
16 element formation portion
17, 17A, 17B, 17C projection
17′ projecting portion
18 bonding wire
18′ feedthrough terminal
25 liquid permeable portion
29 mask
34″ air

1. An optical device comprising a substrate, a sensor having an upper surface in which an element formation portion is formed, the element formation portion including light receiving elements arranged therein to detect light, an optical member guiding the light to the element formation portion, a first bonding material, and a leakage prevention mechanism,
wherein the sensor is mounted to the substrate,
the optical member is arranged to face an upper surface of the sensor,
the first bonding material bonds a region in the upper surface of the sensor other than the element formation portion and a surface of the optical member on side closer to the sensor, and
the leakage prevention mechanism prevents the first bonding material from overflowing onto the light receiving elements in the element formation portion on the upper surface of the sensor.

2. The optical device according to claim 1, wherein the leakage prevention mechanism includes a groove formed in at least part of the surface of the optical member on the side closer to the sensor.

3. The optical device according to claim 1, wherein the leakage prevention mechanism includes a groove formed in the upper surface of the sensor in at least part of the region other than the element formation portion.

4. The optical device according to claim 1, wherein the leakage prevention mechanism includes a liquid permeable portion that is formed in the upper surface of the sensor in at least part of the region other than the element formation portion, and that has affinity to the first bonding material higher than affinity of the element formation portion to the first bonding material.

5. The optical device according to claim 1, wherein the first bonding material has a light-shielding property.

6. The optical device according to claim 1, wherein the first bonding material contains filler.

7. The optical device according to claim 1, wherein the optical member includes a projection on at least part of the surface of the optical member on the side closer to the sensor, and the projection contacts at least part of the upper surface of the sensor.

8. The optical device according to claim 1, wherein the sensor includes a terminal provided in the upper surface of the sensor outside the element formation portion, the sensor and the optical member are not bonded at a position of the terminal by the first bonding material, and the substrate and the terminal are electrically connected.

9. The optical device according to claim 8, wherein the sensor includes a recessed step formed in at least part of the upper surface of the sensor outside the element formation portion, and the terminal is provided on the recessed step.

10. The optical device according to claim 1, wherein the sensor includes a feedthrough terminal penetrating through the sensor from the upper surface of the sensor in the region outside the element formation portion, and the substrate and the feedthrough terminal are electrically connected.

11. The optical device according to claim 1, wherein the optical member includes a projecting portion that projects around an effective region of the optical member up to a position around a lateral surface of the sensor.

12. An optical device comprising a substrate, a sensor having an upper surface in which an element formation portion is formed, the element formation portion including light receiving elements arranged therein to detect light, an optical member guiding the light to the element formation portion, and a first bonding material,
wherein the sensor is mounted to the substrate,
the optical member is arranged to face an upper surface of the sensor, and
the first bonding material bonds a region in the upper surface of the sensor where the element formation portion is formed and a surface of the optical member on side closer to the sensor.

13. The optical device according to claim 12, wherein the first bonding material has optical transparency.

14. The optical device according to claim 13, wherein the first bonding material is filled between the sensor and the optical member.

15. The optical device according to claim 13, wherein a refractive index of the first bonding material is lower than a refractive index of the optical member.

16. The optical device according to claim 12, wherein the first bonding material is one among an oily substance, a gel substance, a liquid substance, and a solid substance.

17. The optical device according to claim 1, wherein the optical member is further bonded to a component of the optical device other than the sensor with a second bonding material interposed therebetween.
